(19) United States
(12) Patent Application Publication
(10) Pub. No.: US 2023/0095641 A1
(43) Pub. Date: Mar. 30, 2023

(54) EVENT ATTENDEE TRACKING VIA WIRELESS TECHNIQUES

(71) Applicant: FORD GLOBAL TECHNOLOGIES, LLC, Dearborn, MI (US)

(72) Inventors: Timothy THIVIERGE, Carleton, MI (US); Vivekanandh ELANGOVAN, Canton, MI (US); Jochen SCHUBERT, Farmington Hills, MI (US)

(21) Appl. No.: 17/486,216

(22) Filed: Sep. 27, 2021

(51) Int. Cl. H04W 4/029; H04W 4/021; H04B 1/7163; G08B 21/18

(52) U.S. Cl. CPC H04W 4/029; H04W 4/021; H04B 1/7163; G08B 21/18

(57) ABSTRACT

Attendance for an event is provided. Wireless sensors are utilized to determine locations over a period of time of wireless devices of attendees of an event. Event materials are provided to the wireless devices using the wireless sensors. Attendance of the attendees at the event is indicated based on the locations over time of the wireless devices of the attendees of the event.

### TECHNICAL FIELD

Aspects of the disclosure generally relate to wireless registration, check in, check out, and tracking systems and methods for attendees of events.

### BACKGROUND

Ultra-Wide Band (UWB) technology has been evolving due to the introduction of this technology in the smartphone. UWB can perform precise Time of Flight (ToF) and Angle of Arrival (AoA) measurements, which may be used for measuring the distance between devices and the angle between which devices are located. These techniques may allow for the precise location of devices.

### SUMMARY

In one or more illustrative embodiments, an attendance system for an event is provided. The system includes wireless sensors and a server programmed to utilize the wireless sensors to determine locations, over a period of time, of wireless devices of attendees of an event, provide event materials to the wireless devices using the wireless sensors, and indicate attendance of the attendees at the event based on the locations over, the period of time, of the wireless devices of the attendees of the event.

In one or more illustrative examples, an attendance method for an event is provided. Wireless sensors are utilized to determine locations over a period of time of wireless devices of attendees of an event. Event materials are provided to the wireless devices using the wireless sensors. Attendance of the attendees at the event is indicated based on the locations over the period of time of the wireless devices of the attendees of the event.

In one or more illustrate examples, a non-transitory computer-readable medium includes instructions that, when executed by a server in communication with wireless sensors over a communication network, causes the server to perform operations including to utilize the wireless sensors to determine locations over a period of time of wireless devices of attendees of an event, the event including a plurality of rooms, each room of the plurality of rooms includes at least one wireless sensor of the wireless sensors, the at least one wireless sensor configured to determine whether the wireless devices are located in a specific room corresponding to the at least one wireless sensor, the wireless sensors including Ultra-Wide Band (UWB) sensors, the locations of wireless devices being determined using Time of Flight (ToF) and Angle of Arrival (AoA) measurements of signals between the wireless devices and the wireless sensors; provide event materials to the wireless devices using the wireless sensors; maintain an event schedule defining a track for each of the wireless devices, the track defining which of the plurality of rooms of the event are authorized for access by the wireless devices; compare the locations over the period of time of the wireless devices to which of the plurality of rooms the wireless devices are authorized to attend; raise an alert responsive to one or more of the wireless devices being in attendance in the one or more rooms that are not authorized for the access or being in the incorrect room; and indicate the track as being a completed status for one device of the wireless devices responsive to the one device attending each of the plurality of rooms of the event are authorized for the access by the one device.

### BRIEF DESCRIPTION OF THE DRAWINGS

FIG. 1 illustrates a system for providing wireless registration, check in, and device tracking;

FIG. 2 illustrates an example plan view of an event, in accordance with the disclosure;

FIG. 3 illustrates an example detail of attendance data, in accordance with the disclosure;

FIG. 4 illustrates an example detail of attendance data indicative of which areas of an event correspond to the tracks of the event, in accordance with the disclosure;

FIG. 5 illustrates an example detail of attendance data, in accordance with the disclosure; and

FIG. 6 illustrates an example process for the automated check in, check out, and provisioning of materials to attendees of the event.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

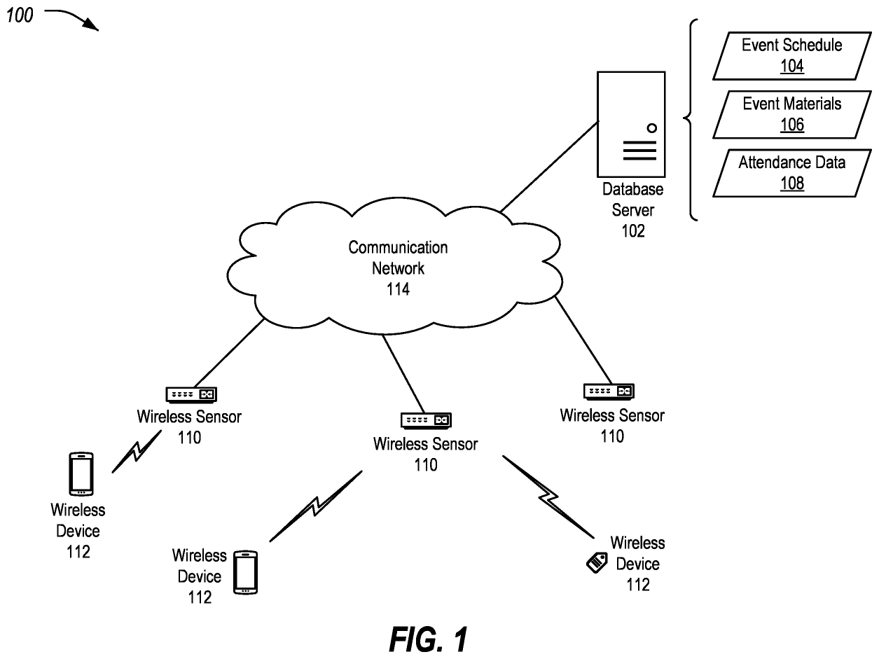

FIG. 1 illustrates a system 100 for providing wireless registration, check in, and device tracking. As illustrated, the system 100 includes a database server 102 maintaining an event schedule 104, event materials 106, and attendance data 108. The system further includes a plurality of wireless sensors 110 configured to track and communicate with wireless devices 112. The database server 102 may be configured to access the wireless sensors 110 via a communication network 114. As explained in detail below, the system 100 may be configured to identify wireless devices 112 authorized to be checked into events, provide the correct event materials 106 to the wireless devices 112, and track attendance data with respect to the attendance of the wireless devices 112 at different areas or sessions of the event.

The database server 102 may include various types of computing apparatus, such as a computer workstation, a server, a desktop computer, a virtual server instance executed by a mainframe server, or some other computing system and/or device. Computing devices, such as the database server 102, generally include a memory on which computer-executable instructions may be maintained, where the instructions may be executable by one or more processors of the computing device. Such instructions and other data may be stored using a variety of computer-readable media. A computer-readable medium (also referred to as a processor-readable medium or storage) includes any non-transitory (e.g., tangible) medium that participates in providing data (e.g., instructions) that may be read by a computer (e.g., by the processor of the database server 102). In general, processors receive instructions, e.g., from the memory via the computer-readable storage medium, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, JAVA, C, C++, C#, FORTRAN, PASCAL, VISUAL BASIC, JAVA SCRIPT, PERL, Structured Query Language (SQL), etc.

The database server 102 may include instructions that, when loaded into memory and executed by the database server 102, cause the database server 102 to perform database functionality including the storage, update, and retrieval of relational information. Databases or data repositories may include various kinds of mechanisms for storing, accessing, and retrieving various kinds of data, including a hierarchical database, a set of files in a file system, an application database in a proprietary format, a relational database management system (RDBMS), etc. An RDBMS generally employs SQL in addition to a language for creating, storing, editing, and executing stored procedures, such as the SQL language mentioned above. As shown, the database server 102 may be configured to maintain information including the event schedule 104, event materials 106, and attendance data 108.

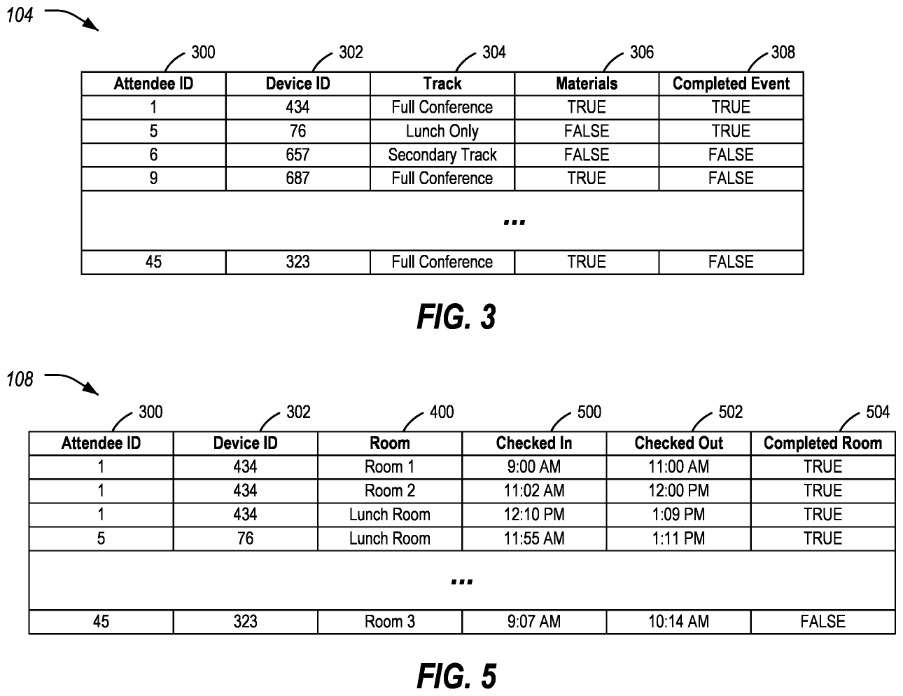

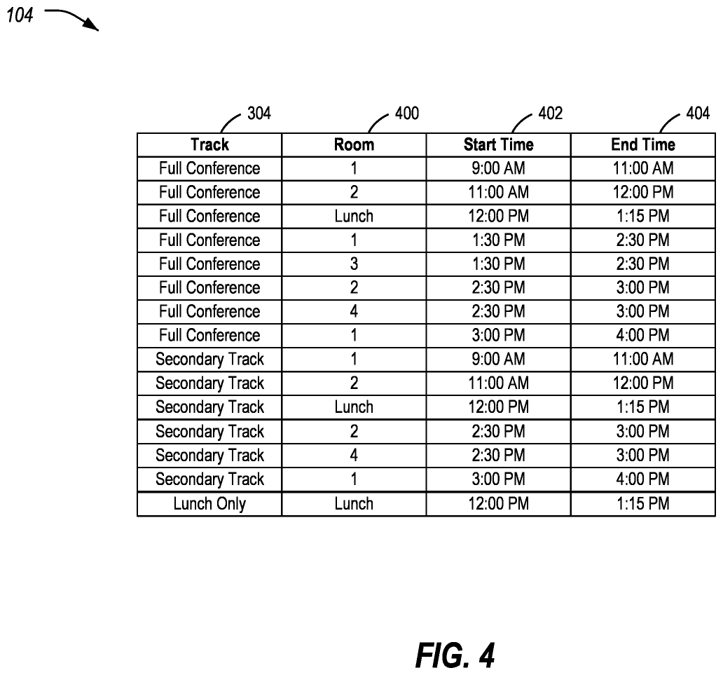

The event schedule 104 may include information indicative of one or more events. An event may be a conference, seminar, test, conference, party, sports game, or other gathering in which attendees may be scheduled to attend at a predefined time and place. In some examples, the event may include a single session and location. For instance, a concert may include a single event in a single auditorium. In other examples, the event may include multiple sessions and/or locations. For instance, a conference may include multiple meetings in different areas (e.g., rooms, portions of a room, areas of a field, booths at a conference, space in front of a particular monitor or display, etc.). In some examples, there may be multiple concurrent meetings or tracks. As one possibility a first set of meetings in a first set of areas may follow a first track of events at a conference, and a second set of meetings in a second set of areas may follow a second track of events at the conference. The event schedule 104 may further include unique identifiers (IDs) of attendees. Based on the IDs, the event schedule 104 may indicate which attendees are checked in or not checked in, as well as which attendees are signed up to attend which meetings, tracks, or sessions. The IDs may also be associated with other attendee information, such as attendee name, attendee contact information, attendee device identifier, etc. Example details of the event schedule 104 are shown in FIGS. 3-4, discussed below.

The event materials 106 may include documents that relate to the subject matter of the event. In an example, the event materials 106 may include materials presented at the event, such as slide presentations. In another example, the event materials 106 may include supporting materials that may be referenced but are not directly presented at the event, such as academic papers. For some events, all event materials 106 may be available to each attendee. For other events, only a portion of the event materials 106 may be appliable or available. For instance, an attendee may sign up for one track of a multiple track event. In such a case, the attendee may only require (or only be given access to) the event materials 106 corresponding to that track.

The attendance data 108 may include information with respect to the timing and location of attendance of the attendees at the event. For instance, the attendance data 108 may include indications of when attendees checked-in to the conference, when the attendees left the conference, which area or areas of the conference the attendees were located in, etc. An example detail of the attendance data 108 is shown in FIG. 5, discussed below.

The wireless sensors 110 may be configured to track the attendees for use in generation of the attendance data 108. For instance, the wireless sensors 110 may operate using various wireless technologies, such as BLUETOOTH Low Energy (BLE), UWB, and/or Wi-Fi. The attendees may be tracked based on wireless devices 112 carried by the attendees. For instance, UWB location technologies such as ToF and AoA may be used to determine the locations of the wireless devices 112, which may serve as proxy for the locations of the event attendees.

In many examples, the wireless devices 112 may be smartphones, tablets, smartwatches, or other wireless devices 112 that are owned by the attendees. In other examples, the wireless devices 112 may be devices that are given to the attendees at the event, such as wireless tag devices. The wireless devices 112 may be programmed to emit the IDs unique for each attendee (and/or identifiers of the wireless devices 112). These IDs may be compared to the IDs specified in the event schedule 104, such that the attendees may be easily tracked by the database server 102.

In another example, the wireless devices 112 may be programed to emit tokens or other cryptographic data generated with a pre-shared key associated with each attendee and/or their device. These tokens or other cryptographic data may be generated responsive to messages from the database server 102 sent to the wireless device 112 using one or more communication networks 114 and/or the wireless sensors 110. These tokens or data may be captured by the wireless sensors 110 and provided to the database server 102 to track the wireless devices 112.

The communication network 114 may include various wired and/or wireless forms of communication configured to allow the wireless sensors 110 to communicate with the database server 102. By communicating over the communication network 114 the database server 102 may be able to receive information from the wireless sensors 110 for creating the attendance data 108. Additionally, the communication over the communication network 114 may be used to allow the database server 102 to send the event materials 106 to the wireless devices 112.

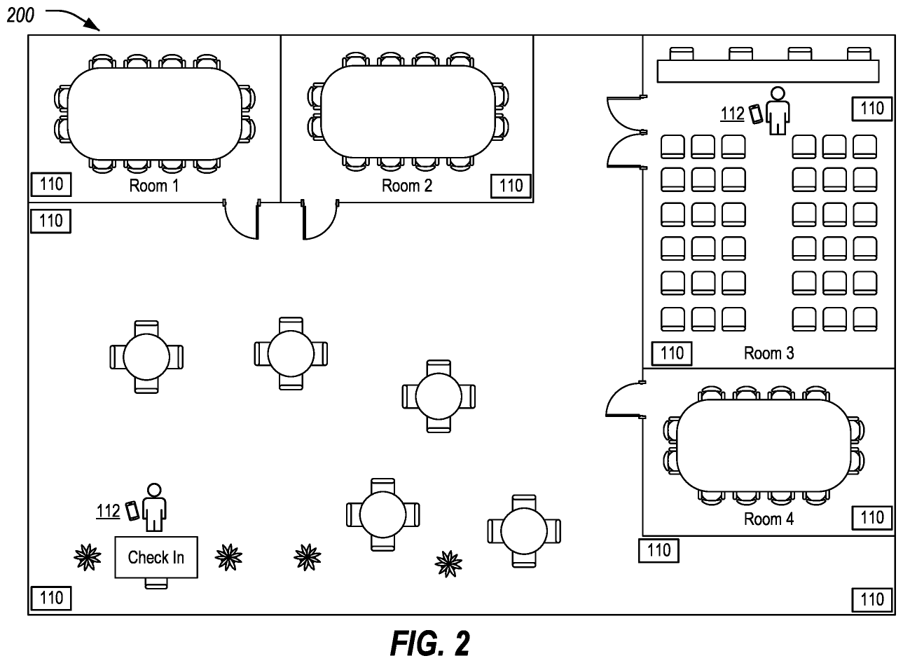

FIG. 2 illustrates an example plan view of an event 200. As shown, the event 200 includes four conference rooms (Room 1, Room 2, Room 3, and Room 4). The event 200 also includes a check in location in an open area. Wireless sensors 110 are located within the rooms and the open area to facilitate the tracking of attendees. As shown, a first attendee is at the check in desk in the open area, while a second attendee is located in Room 3. The wireless devices 112 of these attendees may be used to locate the attendees in their respective locations. It should be noted that this layout is merely illustrative, and events having different layouts and attendees may be used.

FIG. 3 illustrates an example detail of event schedule 104 data. Referring to FIG. 3, and with continued reference to FIGS. 1-2, during an initial registration for the event 200, the attendee may be assigned to an attendee ID 300. This attendee ID 300 may be provided by the database server 102, for instance as a random number or as an autoincremented unique value in a database table. Additionally, this attendee may be associated with a device ID 302 of the wireless device 112 of the attendee. Using one or more of the IDs 300, 302 and the wireless sensors 110, each attendee can be tracked within the event venue using wireless location techniques. For instance, if the attendee ID 300 of the wireless device 112 of the attendee in Room 3 is received as being within a predefined distance to one of the wireless sensors 110 in Room 3, then the attendee may be deemed to be in Room 3.

The event schedule 104 may further indicate a track 304 that specifies permissions for the attendee to attend the various portions of the event. As shown, this may include the full conference, one or more subsets or tracks of the conference, lunch only, etc. Referring to FIG. 4, and with continued reference to FIG. 3, the event schedule 104 may further include data indicative of which rooms 400 of the event correspond to the various tracks 304 of the event. As shown, for each track 304, one or more rooms 400, start time 402 for attendance for that room 400 and end time 404 for attendance of that room 400 are shown. This allows for different levels of access to be provided to different attendees, as well as for providing timing information for tracking where the attended should be and whether the track 304 was actually completed.

Referring back to FIG. 3, the event schedule 104 may also indicate a materials 306 value for each attendee indicative of whether the event materials 106 have been provided to that attendee. For instance, this value may be initially set to FALSE, but later be set to TRUE responsive to sending the event materials 106 to the wireless device 112 corresponding to the attendee (e.g., to the wireless device 112 having the device ID 302).

In some examples, the event schedule 104 may also include a completed event 308 column indicative of whether the attendee actually attended the track 304 of the conference to which the attendee was assigned. This column may be filled out based on the attendance data 108. For instance, the completed event 308 may initially set to FALSE, but if the attendee did attend each of the rooms of the track, the completed event 308 may be set to TRUE.

FIG. 5 illustrates an example detail of attendance data 108. Referring to FIG. 5, and as shown in FIG. 2, each Room or other session location may have one or more wireless sensors 110 which communicates with the wireless device 112 to determine the location of the wireless device 112. Based on the result of the location techniques, the database server 102 may determine which room 400 of the event 200 the attendee is attending. This may also allow the database server 102 to alert users via their wireless device 112 that they are in the wrong location, as well as to track cumulative time spent by wireless devices 112 at each area or room.

The tracking and/or check in may be based on the attendee distance from the wireless sensors 110. This distance threshold to check in or to associate an attendee with a location may be programmable (e.g., may be updated based on the event venue). The ToF measurements between the wireless sensors 110 and the wireless device 112 may be used to determine how close the attendee is located to a session location and to check the attendee in based on the distance measurement and/or also the AoA measurement.

If the user does not have a wireless device 112 enabled with sufficient localization technology (e.g., UWB, BLE, or WiFi with ToF and AoA), then the attendee may be provided with a UWB tag as a wireless device 112. The tag may then be used to emit these UWB signals which can be tracked. These tags may be reusable and handed in at the end of the event or may be given to the attendee and programmed for a future event the attendee is planning to attend.

Using the determined location, the database server 102 may automatically check the attendee corresponding to the wireless device 112 into that room 400 or session. For instance, the database server 102 may record a check in time 500 for the attendee joining the room 400, and a check out time 502 for the attendee leaving the room 400. A completed room 504 value may be initially set to FALSE. If the attendee stays located in the room 400 for the time period specified in the event schedule 104 (e.g., as shown in FIG. 4), then the completed room 504 value may be set to TRUE.

While the example event 200 of FIG. 2 shows an indoor conference event, the described approach is applicable for business events, educational events, vehicle garage check in, etc. For example, an autonomous vehicle being checked into a depot for maintenance, storage, or any other scenario, may use ToF and AoA to check in the vehicle. As another example, the described approach may be implemented in drive in movie theaters where a vehicle UWB tag is validated automatically at the theatre entrance and checked in automatically.

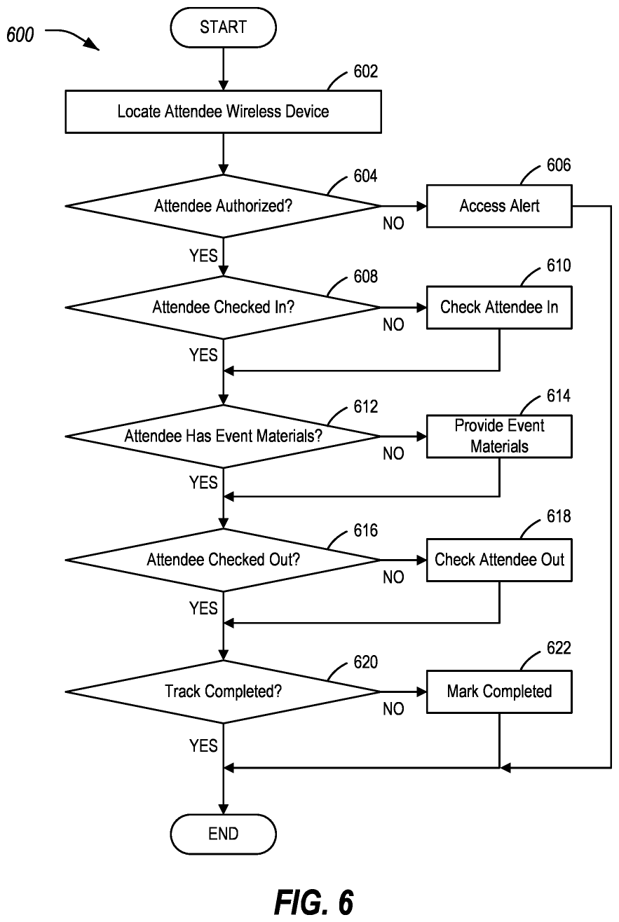

FIG. 6 illustrates an example process 600 for the automated check in, check out, and provisioning of materials to attendees of the event 200. In an example, the process 600 may be performed by the apparatus of the system 100. For instance, the process 600 may be performed by the database server 102 in communication with the wireless sensors 110 over the communication network 114, thereby allowing the database server 102 to track the locations of the wireless devices 112 with respect to the event 200.

At operation 602, the database server 102 locates the wireless devices 112. For instance, the wireless sensors 110 may be located in one or more areas of the event 200, and the locations of the wireless devices 112 may be tracked using ToF and AoA techniques. In an example, if a wireless device 112 is located closest to a wireless sensor 110 in a particular area, then the wireless device 112 may be deemed to be located within that area.

At operation 604, the database server 102 determines whether the wireless device 112 is authorized to be at the event 200. For instance, based on the area identified at operation 602, the database server 102 may access the event schedule 104 to determine whether the device ID 302 of the wireless device 112 (and/or the attendee ID 300 broadcast by the wireless device 112) is authorized to be in attendance in the area according to the event schedule 104. For instance, if the event schedule 104 does not include an entry for the attendee, then control passes to operation 606 to indicate an alert condition. Or, if the event schedule 104 does include an entry for the attendee but not for the area and current time, control may also pass to operation 606. Or, if the event schedule indicates that the attendee is in the wrong location, control may also pass to operation 606. If the event schedule 104 indicates the current area is authorized for the attendee pursuant to the event schedule 104, control passes to operation 608.

At operation 606, the database server 102 raises an alert. In an example, this may include sending a message to the wireless device 112 (e.g., via the device ID 302), informing the attendee that the attendee is not authorized to attend (or that the attendee is at the wrong location). In another example, this may include informing staff of the event 200 that there is an attendee at the area that is not authorized. After operation 606 the process 600 ends.

At operation 608, the database server 102 determines whether the wireless device 112 is checked in. For instance, the database server 102 may access the attendance data 108 to identify whether the wireless device 112 was previously located in the area in which the wireless device 112 is now located. If so, then the wireless device 112 does not require check in. If, however, the wireless device 112 has moved and is now in a different area, then the process 600 proceeds to operation 610 to check the wireless device 112 into the area.

At operation 610, the database server 102 checks the wireless device 112 into the area. For example, as shown in FIG. 5, the attendance data 108 may add a row to the attendance data 108 indicating the check in time 500 of the wireless device 112 to the area. After operation 610 control proceeds to operation 612.

At operation 612, the database server 102 determines whether the wireless device 112 has the event materials 106. In an example, the database server 102 accesses the event schedule 104 (e.g., via the device ID 302) to determine whether event materials 106 were provided to the attendee. If not, control passes to operation 614 to provide the event materials 106 to the wireless device 112 via the wireless sensors 110. After operation 614, or if event materials 106 are not required to be provided at operation 612, control passes to operation 616.

At operation 616, the database server 102 determines whether the attendee has checked out. For instance, the database server 102 may access the attendance data 108 to identify whether the wireless device 112 was previously located in the area and now is no longer in the area. If so, then the process 600 proceeds to operation 618 to check the wireless device 112 out of the area and record the check-out time 502 time into the attendance data 108.

At operation 618, the database server 102 checks the wireless device 112 out of the area. For example, as shown in FIG. 5, the attendance data 108 may fill in the row of the attendance data 108 indicating the check-out time 502 of the wireless device 112 from the area. The database server 102 may also access the event schedule 104 for the track of the attendee to determine whether the attendee has stayed in the area for the time specified by the start time 402 and end time 404 of the room 400 for the track 304. If so, then the database server 102 marks the completed room 504 for the attendee and area as TRUE. The database server 102 may also track the cumulative time that the wireless device 112 is at each area. After operation 618, or after operation 616 if no check out is required, control passes to operation 620.

At operation 620, the database server 102 determines whether the track is completed for the attendee. For example, the database server 102 may access the event schedule 104 for the track of the attendee and the attendance data 108 for the attendee, and determine if each of the rooms 400 of the track 304 of the attendee marked as completed rooms 504. If so, control passes to operation 622 to mark a completed event 310 field in the event schedule 104 as completed for the attendee.

After operation 620, the process 600 ends. It should be noted that the process 600 may be performed continuously throughout the event 200 to track the attendees. Moreover, one or more operations of the process 600 may be performed concurrently or in an order other than as shown in the FIG. 6.

Computing devices described herein, such as the database server 102, wireless sensors 110, and wireless devices 112 generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

1. An attendance system for an event, comprising:
wireless sensors; and
a server programmed to
utilize the wireless sensors to determine locations, over a period of time, of wireless devices of attendees of an event,
provide event materials to the wireless devices using the wireless sensors, the event materials including documents being presented at the event, and
indicate attendance of the attendees at the event based on the locations over the period of time of the wireless devices of the attendees of the event.

2. The system of claim 1, wherein the wireless sensors include Ultra-Wide Band (UWB) sensors, and the server is further programmed to determine the locations of the wireless devices using Time of Flight (ToF) and Angle of Arrival (AoA) measurements of signals between the wireless devices and the wireless sensors.

3. The system of claim 1, wherein the event includes a plurality of areas, each area of the plurality of areas includes at least one wireless sensor of the wireless sensors, and the at least one wireless sensor configured to determine whether the wireless devices are located in a specific area corresponding to the at least one wireless sensor.

4. The system of claim 3, wherein the locations over a period of time of the wireless devices include check in times of the wireless devices entering areas of the plurality of areas and check out times of the wireless devices exiting areas of the plurality of areas.

5. The system of claim 3, wherein the server is further programmed to track a total amount of time a wireless device is located within each of the plurality of areas.

6. The system of claim 3, wherein the server is further programmed to:
maintain an event schedule defining a track for each of the wireless devices, the track defining which of the plurality of areas of the event are authorized for access by the wireless devices;
compare the locations over the period of time of the wireless devices to which of the plurality of areas the wireless devices are authorized to attend; and
raise an alert responsive to one or more of the wireless devices being in attendance in areas that are not authorized for the access.

7. The system of claim 3, wherein the server is further programmed to:
maintain an event schedule defining a track for each of the wireless devices, the track defining which of the plurality of areas of the event are authorized for access by the wireless devices;
compare the locations over the period of time of the wireless devices to which of the plurality of areas the wireless devices are authorized to attend; and
raise an alert responsive to one or more of the wireless devices being located in a different location than indicated by the event schedule.

8. The system of claim 7, wherein the server is further programmed to indicate the track as being a completed status for one device of the wireless devices responsive to the one device attending each of the plurality of areas of the event that are authorized for access by the one device.

9. The system of claim 8, wherein the completed status provides an attendee corresponding to the one device with credit for attendance at the event.

10. The system of claim 1, wherein the wireless devices include mobile phones of attendees, and the locations over time of the wireless devices are tracked based on device identifiers of the mobile phones.

11. The system of claim 1, wherein the wireless devices include mobile phones of the attendees, and the locations over time of the wireless devices are tracked based on tokens or cryptographic data generated by the mobile phones based on data received to the mobile devices from the server.

12. The system of claim 1, wherein the wireless devices include UWB tags assigned to attendees, and the locations over time of the wireless devices are tracked based on the UWB tags.

13. An attendance method for an event, comprising:
utilizing wireless sensors to determine locations over time of wireless devices of attendees of an event;
providing event materials to the wireless devices using the wireless sensors, the event materials including documents being presented at the event and/or supporting materials referenced during the event but not directly presented at the event; and
indicating attendance of the attendees at the event based on the locations over time of the wireless devices of the attendees of the event.

14. The method of claim 13, wherein the wireless sensors include Ultra-Wide Band (UWB) sensors, and further comprising determining the locations of the wireless devices using Time of Flight (ToF) and Angle of Arrival (AoA) measurements of signals between the wireless devices and the wireless sensors.

15. The method of claim 13, wherein the event includes a plurality of areas, each area of the plurality of areas includes at least one wireless sensor of the wireless sensors, and the at least one wireless sensor configured to determine whether the wireless devices are located in a specific area corresponding to the at least one wireless sensor.

16. The method of claim 15, wherein the locations over time of the wireless devices include check in times of the wireless devices entering areas of the plurality of areas and check out times of the wireless devices exiting areas of the plurality of areas.

17. The method of claim 16, further comprising:
maintaining an event schedule defining a track for each of the wireless devices, the track defining which of the plurality of areas of the event are authorized for access by the wireless devices;
comparing the locations over time of the wireless devices to which of the plurality of areas the wireless devices are authorized to attend; and
raising an alert responsive to one or more of the wireless devices being in attendance in areas that are not authorized for the access.

18. The method of claim 17, further comprising indicating the track as being a completed status for one device of the wireless devices responsive to the one device attending each of the plurality of areas of the event are authorized for the access by the one device.

19. The method of claim 18, wherein the completed status provides an attendee corresponding to the one device with credit for attendance of the event.

20. A non-transitory computer-readable medium comprising instructions that, when executed by a server in communication with wireless sensors over a communication network, causes the server to perform operations including to:
utilize the wireless sensors to determine locations over a period of time of wireless devices of attendees of an event, the event including a plurality of rooms, each room of the plurality of rooms includes at least one wireless sensor of the wireless sensors, the at least one wireless sensor configured to determine whether the wireless devices are located in a specific room corresponding to the at least one wireless sensor, the wireless sensors including Ultra-Wide Band (UWB) sensors, the locations of the wireless devices being determined using Time of Flight (ToF) and Angle of Arrival (AoA) measurements of signals between the wireless devices and the wireless sensors;
provide event materials to the wireless devices using the wireless sensors, the event materials including documents being presented at the event and/or supporting materials referenced during the event but not directly presented at the event;
maintain an event schedule defining a track for each of the wireless devices, the track defining which of the plurality of rooms of the event are authorized for access by the wireless devices, wherein, for each respective wireless device of the wireless devices, the event materials include only the event materials corresponding to the rooms of the event that are authorized for access for the respective wireless device;
compare the locations over a period of time of the wireless devices to which of the plurality of rooms the wireless devices are authorized to attend;
raise an alert responsive to one or more of the wireless devices being in attendance in the rooms that are not authorized for the access or being in an incorrect one of the rooms; and
indicate the track as being a completed status for one device of the wireless devices responsive to the one device attending each of the plurality of rooms of the event are authorized for the access by the one device.

21. The medium of claim 20, wherein a first of the wireless devices is assigned to a first track requiring access to a first set of the rooms of the event, and a second of the wireless devices is assigned to a second track requiring access to a second set of the rooms of the event, the first set of the rooms and the second set of the rooms being different sets.

22. The medium of claim 20, wherein the event schedule specifies start times and end times for attendance of the wireless devices within the rooms to receive credit for attending the rooms.

23. The medium of claim 22, further comprising instructions that, when executed by the server, cause the server to:
record check in times responsive to the wireless devices entering the rooms;
record check out times responsive to the wireless devices exiting the rooms; and
indicate that the wireless devices receive credit for attending the rooms responsive to the check in times and check out times indicating that the wireless devices were within the rooms between the start times and end times specified by the event schedule.

24. The system of claim 1, wherein the event materials further include supporting materials referenced but not directly presented at the event.

25. The system of claim 6, wherein, for each respective wireless device of the wireless devices, the event materials include only the portion of the event materials corresponding to the areas of the event that are authorized for access for the respective wireless device.

26. The medium of claim 21, further comprising instructions that, when executed by the server, causes the server to perform operations including to:
provide, to the first of the wireless devices using the wireless sensors, a first portion of the event materials, the first portion of the event materials corresponding to the first track; and
provide, to the second of the wireless devices using the wireless sensors, a second portion of the event materials, the second portion of the event materials corresponding to the second track.
